(19) United States
(12) Patent Application Publication
(10) Pub. No.: US 2014/0282905 A1
(43) Pub. Date: Sep. 18, 2014

(54) SYSTEM AND METHOD FOR THE AUTOMATED CONTAINMENT OF AN UNAUTHORIZED ACCESS POINT IN A COMPUTING NETWORK

(71) Applicant: ARUBA NETWORKS, INC., Sunnyvale, CA (US)

(72) Inventors: Pradeep IYER, Cupertino, CA (US); Prabhjot SETHI, Bangalore (IN)

(73) Assignee: ARUBA NETWORKS, INC., Sunnyvale, CA (US)

(21) Appl. No.: 14/204,797

(22) Filed: Mar. 11, 2014

Related U.S. Application Data
(60) Provisional application No. 61/790,191, filed on Mar. 15, 2013.

(51) Int. Cl. H04W 12/08

(52) U.S. Cl. CPC H04W 12/08
USPC 726/4

(57) ABSTRACT

A method and apparatus for automatic containment of unauthorized access points in a computing network is described. The method may include receiving data indicative of at least a device identifier corresponding to an unauthorized access point. The method may also include, in response to locating the received device identifier in a listing of device identifiers that are associated with data transmissions through the network device, identifying a port of a network device as the port to which the unauthorized access point is connected.

### BENEFIT CLAIM

This non-provisional application claims the benefit of provisional application Ser. No. 61/790,191 filed on Mar. 15, 2013, which is hereby incorporated by reference.

### TECHNICAL FIELD

Embodiments of the invention relate to the field of wireless communications, in particular, to the automatic containment of unauthorized access points in a computing network.

### BACKGROUND

Over the last decade or so, for most businesses, it has become a necessity for employees to share data over an enterprise network featuring one or more local area networks. To improve efficiency, enhancements have added to a local area network such as remote wireless access. This enhancement provides an important extension in forming a wireless local area network.

Typically, a WLAN supports communications between wireless stations and Access Points (APs). In general, each AP operates as a relay station by supporting communications with both wireless stations being part of a wireless network and resources of a wired network.

In addition to APs and corresponding wireless stations, conventional WLANs feature passive monitoring systems. These systems are configured to simply scan traffic on the WLAN and to conduct performance tasks based on recognized behavior. For example, one performance task may involve measuring signal strength. Another performance task may involve determining whether an AP detected within a wireless coverage area is unauthorized.

If any problems are detected, conventional monitoring systems do not have any capability to correct such problems. Instead, a notification is sent by the system to an administrator. For instance, upon detection of an unauthorized AP, the passive monitoring system currently sends a notification to an administrator to prevent wireless stations in the area from accessing the unauthorized AP. This inability of monitoring systems to automatically handle such problems may cause undesirable latency in correcting problems and increased overall administrative costs. In addition, mere notification adversely affects overall security of the network by increasing its exposure to hackers.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of exemplary system architecture for containment of unauthorized access points in a computing network.

FIG. 2 is a block diagram of one embodiment of an unauthorized access point containment system.

FIG. 3 is a flow diagram of one embodiment of a method for generating device identifiers corresponding to an unauthorized AP.

FIG. 4 is a flow diagram of one embodiment of a method for the automatic containment and remediation of an unauthorized AP.

### DETAILED DESCRIPTION

In the following description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Herein, the invention may be applicable to a variety of wireless networks such as a wireless local area network (WLAN) or wireless personal area network (WPAN). The WLAN may be configured in accordance with any Institute of Electrical and Electronics Engineers (IEEE) 802.11 standard such as an IEEE 802.11b standard entitled “Wireless LAN Medium Access Control (MAC) and Physical Layer (PHY) specifications: Higher-Speed Physical Layer Extension in the 2.4 GHz Band” (IEEE 802.11b, 1999), an IEEE 802.11a standard entitled “Wireless LAN Medium Access Control (MAC) and Physical Layer (PHY) specifications: High-Speed Physical Layer in the 5 GHz Band” (IEEE 802.11a, 1999) or a revised IEEE 802.11 standard “Wireless LAN Medium Access Control (MAC) and Physical Layer (PHY) specifications” (IEEE 802.11, 1999). Of course, the invention may be compliant with systems configured in accordance with High Performance Radio Local Area Networks (HiperLAN) or subsequently published specifications.

FIG. 1 is a block diagram of exemplary system architecture 100 for containment of unauthorized access points in a computing network. System architecture 100 includes a plurality of network devices, such as router 102, network switch 104, wireless access point (AP) 108, and unauthorized AP 150 that form a computing network. Furthermore, although only a single router, network switch, wireless AP, and unauthorized AP are illustrated, the network illustrated by system architecture 100 may include one or more of each of the different network devices consistent with the discussion herein.

In one embodiment, the network further includes at least one unauthorized AP 150. In one embodiment, the unauthorized AP 150 is referred to as unauthorized because it does not have permission to connect with the network. Such unauthorized access points pose a threat to network security and enterprise resources in that they may disrupt service within the network, install malicious content (e.g., computer viruses) on network devices and/or client devices, as well as pose many other security concerns. Identification as to which APs in a network are unauthorized may be performed in accordance with techniques describe in U.S. Pat. No. 6,957,067 (“System and Method for Monitoring and Enforcing Policy Within a Wireless Network”) assigned to the corporate assignee of the present invention and incorporated herein by reference.

In one embodiment, the network illustrated in architecture 100 may run on one Local Area Network (LAN) and may be incorporated into the same physical or logical system, or different physical or logical systems. Alternatively, the network may reside on different LANs, wide area networks, etc. that may be coupled together via the Internet but separated by firewalls, routers, and/or other network devices. It should be noted that various other network configurations can be used including, for example, hosted configurations, distributed configurations, centralized configurations, etc.

The system architecture 100 further includes one or more client computing devices 120 and 125 coupled to the network via wireless AP 108 and unauthorized AP 150. Client computing devices 120 and 125 connect to the network via wireless AP 108 and unauthorized AP 150 to access services such as the Internet through network switch 104 and router 102. Furthermore, each AP 108 may support simultaneous communication with a plurality of different client computing devices.

In one embodiment, router 102, network switch 104, wireless AP 108, and unauthorized AP 150 are purpose-made digital devices, each containing a processor, memory hierarchy, and input-output interfaces. In one embodiment of the invention, a MIPS-class processor such as those from Cavium or RMI is used. Other suitable processors, such as those from Intel or AMD may also be used. The memory hierarchy traditionally comprises fast read/write memory for holding processor data and instructions while operating, and nonvolatile memory such as EEPROM and/or Flash for storing files and system startup information. Wired interfaces are typically IEEE 802.3 Ethernet interfaces, used for wired connections to other network devices such as switches, or to a controller. Wireless interfaces may be WiMAX, 3G, 4G, and/or IEEE 802.11 wireless interfaces. In one embodiment of the invention, controllers, switches, and wireless APs operate under control of a LINUX® operating system, with purpose-built programs providing controller and access point functionality.

Client computing devices 120 and 125 also contain a processor, memory hierarchy, and a number of interfaces including a wired and/or wireless interfaces for communicating with network switch 104 via wireless AP 108 and unauthorized AP 150. Typical client computing devices include personal computers, handheld and tablet computers, Wi-Fi phones, wireless barcode scanners, and the like.

In one embodiment, network switch 104 processes and routes data between network devices, such as AP 108 and router 102. In order to processes and route the data, both the router 102 and wireless AP 108 are coupled with the network switch 104 via physical ports (not shown) of the switch. The switch then processes and routes data between network devices via the port connections at the data link layer, utilizing, for example, the link layer discovery protocol (LLDP). However, when one or more unauthorized APs, such as unauthorized AP 150, couple to ports of the network switch, the security risks discussed above are created.

In one embodiment, wireless AP 108 and network switch 104 may automatically contain the unauthorized AP 150, without the intervention of a network administrator, and apply one or more security policies to the contained unauthorized AP 150. In one embodiment, wireless AP 108 includes an unauthorized AP data collector 110 and network switch 104 includes an unauthorized AP remediator 106. In one embodiment, unauthorized AP data collector 110 and unauthorized AP remediator 106 are software, hardware, or firmware logic executed on wireless AP 108 and network switch 104.

In one embodiment, unauthorized AP data collector 110 of wireless AP 108 determines identifiers for the unauthorized AP 150 and one or more unauthorized computing devices, such as computing device 120 coupled with unauthorized AP 150. In one embodiment, unauthorized AP data collector 110 monitors the wireless and wired communication addressing in the data packets exchanged between network switch 104, unauthorized AP 150, and computing device 120. In one embodiment, in accordance with the 802.11 standard, data communicated over the illustrated network include data packets divided into different segments. The segments, include at least a segment that includes a source media access control (MAC) address corresponding to the device that originated the communication, a segment that includes a destination MAC address corresponding to the device that is the intended recipient of the of the communication, and a basic service set identifier (BSSID) associated with the unauthorized AP 150. Data packets in 802.11 include more segments than those discussed herein. However, the discussion herein will focus on these segments to avoid obscuring the present invention. Furthermore, in an alternative embodiment, the unauthorized AP data collector 110 may reside in an air monitor (not shown) and not wireless AP 108, where the air monitor is also a purpose built device for monitoring network traffic, but does not provide network access to client computing devices.

In one embodiment, the unauthorized AP data collector 110 builds a plurality of tables of device identifiers (e.g., the MAC addresses of the unauthorized AP 150 and computing devices 120). For example, unauthorized AP data collector 110 monitors the network traffic with respect to unauthorized AP 150, and creates a table of all wireless MAC addresses that are listed in a source address segment of data packets that flow through unauthorized AP 150 to network switch 104. Similar tables are also built by unauthorized AP data collector 110 for data packets that include the unauthorized AP's 150 BSSID in the wired segment of data packets, and wired MAC addresses learned from the data traffic with unauthorized AP 150 where an organizationally-unique identifier (OUI) in the wired MAC address matches the OUI of the unauthorized AP's 150 BSSID. In one embodiment, unauthorized AP data collector 110 extracts these device identifiers (e.g., MAC addresses and BSSIDs) by monitoring the addressing information within data packets flowing to and from the unauthorized AP 150. The device identifiers/MAC addresses in the tables generated by unauthorized AP data collector 110 may then be blacklisted as being identifiers for devices associated with unauthorized AP 150.

Once unauthorized AP data collector 110 has constructed the tables of MAC address device identifiers, unauthorized AP data collector 110 sends the unauthorized AP remediator 106 one or more of the tables. Unauthorized AP remediator 106 of network switch 104 receives the tables and compares the MAC addresses in the received tables with MAC addresses in a bridge table maintained by network switch 104. As discussed herein, a bridge table is a table where network switch 104 accumulates and stores a listing of MAC addresses of devices that are sending and receiving data through the switch, and also includes an indication of the physical port of network switch 104 through which the communication is occurring. In one embodiment, unauthorized AP remediator 106 compares the received blacklisted MAC addresses against the MAC addresses in the network switch's 104 bridge table. When unauthorized AP remediator 106 finds a match, i.e., a blacklisted MAC address is listed in the bridge table as a MAC address for a device communicating data, unauthorized AP remediator 106 identifies the port of the network switch 104 from the matched MAC address and the bridge table.

In one embodiment, identification of the actual port of network switch 104 to which unauthorized AP 150 is connected enables unauthorized AP remediator 106 to automatically contain the unauthorized AP 150, and any data traffic flowing to or from the unauthorized AP 150. For example, unauthorized AP remediator 106 may automatically perform one or more containment operations, such as turning off the identified port that unauthorized AP 150 is connected to, turning off power over ethernet (PoE) to the identified port, permanently blacklisting the identified MAC address of the unauthorized AP 150 so that the MAC address is not re-learned by network switch 104 in the future, instructing one or more network devices to monitor traffic flowing to and from unauthorized AP 150 to learn what data (e.g., sensitive enterprise data) is being exchanged, etc.

In one embodiment, unauthorized AP data collector 110 monitors the particular MAC addresses and BSSIDs discussed above in order to ensure that only the correct port of network switch 104 is affected by the containment operations. That is, merely monitoring the destination addresses in data traffic may result in incorrectly identifying the router's 102 MAC address. If the port that router 102 uses to connect with network switch 104 is turned off, the network enabled by network switch 104 would be disconnected from the enterprise, Internet, etc.

In the embodiment illustrated in FIG. 1, the unauthorized AP remediator 106 and the unauthorized AP data collector 110 are deployed in a network switch and a wireless AP, respectively. However, in embodiments, the unauthorized AP remediator 106 and the unauthorized AP data collector 110 may be deployed in additional network devices. For example, unauthorized AP remediator 106 can be deployed, in accordance with the discussion herein, in any network device having one or more physical switches for routing data traffic over a network. Furthermore, unauthorized AP data collector 110 can be deployed in any network device capable of monitoring network traffic.

FIG. 2 is a block diagram of one embodiment 200 of an unauthorized access point containment system. Unauthorized AP data collector 210 and unauthorized AP remediator 206, as illustrated in FIG. 2, provide additional details for the unauthorized AP data collector 110 and unauthorized AP remediator 106 discussed above in FIG. 1.

In one embodiment, unauthorized AP data collector 210 is deployed in wireless AP 208 and includes a unauthorized AP identifier 220, data traffic monitor 222, device ID analyzer 224, and unauthorized AP identifier storage 226. In one embodiment, wireless AP 208 is coupled with network switch 204 via a physical port (not shown), and communicates with network switch 204 via the LLDP. In one embodiment, unauthorized AP remediator 206 is deployed in network switch 204 and includes a device identifier correlator 240 and a corrective action initiator 244.

In one embodiment, with reference to unauthorized AP data collector 210, unauthorized AP identifier 220 is responsible for informing data traffic monitor 222 as to the identity of unauthorized AP 250. In one embodiment, identification of AP 250 as unauthorized, as well as identification of the computing devices (not shown) coupled with unauthorized AP 250 may be performed by unauthorized AP identifier 220 in accordance with techniques describe in U.S. Pat. No. 6,957,067 (“System and Method for Monitoring and Enforcing Policy Within a Wireless Network”). In an alternative embodiment, not shown, the identification of an unauthorized AP and corresponding computing devices is performed by another network device, and results of the identification are transmitted, or otherwise transferred to, unauthorized AP identifier 220.

In one embodiment, data traffic monitor 222 utilizes the identity of the unauthorized AP 250 to monitor data traffic, both wired and wireless, to and from unauthorized AP 250. In one embodiment, from the monitored data traffic, data traffic monitor 222 creates a plurality of tables 228-1 through 228-N in unauthorized AP identifier storage 226.

Device identifier analyzer 224 then analyzes the tables 228-1 through 228-N to extract the device identifiers/MAC addresses that are to be blacklisted. In one embodiment, the blacklisted MAC addresses correspond to the MAC address of the unauthorized AP 250, and client computing devices (not shown) that are coupled with unauthorized AP 250. In one embodiment, data extracted from the tables includes the MAC addresses, as well as other identifiers, that will inform unauthorized AP remediator 206 as to which ports of network switch 204 to perform containment actions upon. Device identifier analyzer 224 extracts data from one or more of a first table that includes wireless MAC addresses that are listed in a source address segment of data packets that flow through unauthorized AP 150 to network switch 104, extracts data from a second table that includes monitored data packets that include the unauthorized AP's 150 BSSID in the wired segment of data packets, and extracts data from a third table built from wired MAC addresses learned from the data traffic with unauthorized AP 150 where an organizationally-unique identifier (OUI) in the wired MAC address matches the OUI of the unauthorized AP's 150 BSSID. In one embodiment, device identifier analyzer 224 extracts these device identifiers from the tables of monitored network traffic to ensure that the corrective actions, performed by unauthorized AP remediator 206 will not be performed on the incorrect port of network switch 204.

Device identifier analyzer 224 communicates the extracted identifiers to device identifier correlator 240. In one embodiment, device identifier correlator 240 compares the received identifiers (i.e., MAC addresses and/or BSSIDs) to bridge table 242. As discussed above, the bridge table 242 is a table where network switch 204 stores MAC addresses of the devices that are sending and receiving data through the switch, and also includes an indication of the port of network switch 204 through which the communication is occurring. When device identifier correlator 240 finds a match in the received extracted identifiers and the identifiers stored in the bridge table 242, device identifier correlator 240 may inform corrective action initiator 244 as to the physical port of network switch 204 where the match occurs.

In one embodiment, corrective action generator 244 may then perform one or more policy based corrective actions on the identified port of network switch 204. The corrective actions may contain the unauthorized AP 250 by turning off the identified port to which the unauthorized AP 250 is connected, turning of the power to the port, generating a notification to a network administrator as the specific port to which the unauthorized AP 250 is connected, monitor the network traffic to and from the unauthorized AP 250 for data loss prevention analysis, etc.

FIG. 3 is a flow diagram of one embodiment of a method 300 for generating device identifiers corresponding to an unauthorized AP. The method 300 is performed by processing logic that may comprise hardware (circuitry, dedicated logic, etc.), software (such as is run on a general purpose computer system, networking device, or other dedicated machine), firmware, or a combination. In one embodiment, the method 300 is performed by unauthorized AP data collector 110 or 210.

Referring to FIG. 3, processing logic begins by building one or more tables of device addresses from network traffic monitored with respect to an unauthorized AP (processing block 302). As discussed above, a plurality of tables are built from the monitored wired and wireless traffic to and from the unauthorized AP. Processing logic then extracts at least one device identifier related to the unauthorized AP from the table (processing block 304). As discussed above, the extracted identifiers may include wireless client device MAC addresses, the unauthorized AP BSSID, and wired MAC addresses of client devices where an OUI matches the OUI of the unauthorized MAC's BSSID. Furthermore, the extracted identifiers include only identifiers of the unauthorized AP, or client computing devices connected to the AP. As a result, these device identifiers may be blacklisted as being, or taking part in, unauthorized use of an enterprise network. Processing logic transmits the at least one extracted identifier to a network switch for unauthorized AP containment (processing block 306). In one embodiment, processing logic periodically sends the network switch the extracted device identifiers. In another embodiment, processing logic send the network switch the extracted device identifiers immediately upon their detection.

FIG. 4 is a flow diagram of one embodiment of a method 400 for the automatic containment and remediation of an unauthorized AP. The method 400 is performed by processing logic that may comprise hardware (circuitry, dedicated logic, etc.), software (such as is run on a general purpose computer system, networking device, or other dedicated machine), firmware, or a combination. In one embodiment, the method 400 is performed by unauthorized AP remediator 104 or 204.

Referring to FIG. 4, processing logic begins by receiving one or more device identifiers corresponding to an unauthorized AP to be contained (processing block 402). As discussed above, the device identifiers have been extracted from tables of monitored network traffic, and correspond to device identifiers that identify an unauthorized AP and devices connected with an unauthorized AP. In either case, processing logic compares the device identifiers against device identifiers in a network switch bridge table (processing block 404) and determines where a match occurs (processing block 406). Because the bridge table stores device addresses for devices transmitting data to and from the switch, and includes the port through which the data flows, the results of comparison of blacklisted device IDs to the bridge table enable processing logic to determine a port to which the unauthorized AP is connected. Processing logic may then automatically, and without the need to notify or wait for the services of a network administrator, perform one or more corrective actions to contain the unauthorized AP (processing block 408). The corrective actions may be selected from a range of containment actions, such as turning off a port or monitoring data traffic content to/from the unauthorized AP. Furthermore, the type of corrective action may be selected by processing logic based on one or more network security policies.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “locating”, “identifying”, “initiating”, or the like, refer to the actions and processes of a computer system, or similar electronic computing devices, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

We claim:

1. A network device comprising:
a memory to store a bridge table; and
a processor to execute an unauthorized access point (AP) remediator to
receive data indicative of at least a device identifier corresponding to an unauthorized access point, and
in response to location of the received device identifier in a listing of device identifiers that are associated with data transmissions through the network device, identify a port of the network device as the port to which the unauthorized access point is connected.

2. The network device of claim 1, wherein in response to the identification of the port of the network device as the port to which the unauthorized access point is connected, the processor to automatically initiate one or more corrective actions with respect to the port to which the unauthorized access point is connected.

3. The network device of claim 1, wherein the data indicative of at least the device identifier comprises one or more device identifiers including a basic service set identifier corresponding to the unauthorized access point.

4. The network device of claim 1, wherein the data indicative of at least the device identifier comprises one or more device identifiers including one or more wireless device identifiers corresponding to one or more wireless devices transmitting data to or from the unauthorized access point.

5. The network device of claim 1, wherein the data indicative of at least the device identifier comprises one or more device identifiers including at least one wired device identifier for a device where a second organizationally-unique device identifier associated for the device matches a corresponding organizationally-unique device identifier in a basic service set identifier of the unauthorized access point.

6. The network device of claim 1, wherein the data indicative of at least the device identifier is received from an authorized device coupled with the network device, where the authorized device monitors device identifiers in data traffic between devices and access points coupled with the network device, and data traffic between the access points and the network device.

7. An article of manufacture having one or more non-transitory computer readable storage media storing executable instructions thereon which when executed cause a system to perform a method comprising:
receiving data indicative of at least a device identifier corresponding to an unauthorized access point; and
in response to locating the received device identifier in a listing of device identifiers that are associated with data transmissions through a network device, identifying a port of the network device as the port to which the unauthorized access point is connected.

8. The article of manufacture of claim 7, further comprising:
in response to the identification of the port of the network device as the port to which the unauthorized access point is connected, automatically initiating one or more corrective actions with respect to the port to which the unauthorized access point is connected.

9. The article of manufacture of claim 7, wherein the data indicative of at least the device identifier comprises one or more device identifiers including a basic service set identifier corresponding to the unauthorized access point.

10. The article of manufacture of claim 7, wherein the data indicative of at least the device identifier comprises one or more device identifiers including one or more wireless device identifiers corresponding to one or more wireless devices transmitting data to or from the unauthorized access point.

11. The article of manufacture of claim 7, wherein the data indicative of at least the device identifier comprises one or more device identifiers including at least one wired device identifier for a device where a second organizationally-unique device identifier associated for the device matches a corresponding organizationally-unique device identifier in a basic service set identifier of the unauthorized access point.

12. The article of manufacture of claim 7, wherein the data indicative of at least the device identifier is received from an authorized device coupled with the network device, where the authorized device monitors device identifiers in data traffic between devices and access points coupled with the network device, and data traffic between the access points and the network device.

13. A network device, comprising:
a memory to store a one or more data tables; and
a processor to execute an unauthorized access point (AP) data collector to
extract data indicative of at least a device identifier based on monitored data communications of an unauthorized access point, and
transmit, to a second network device coupled with the unauthorized access point, data indicative of at least the device identifier, wherein the device identifier enables the second network device to identify a port of the second network device as the port to which the unauthorized access point is connected.

14. The network device of claim 13, wherein the processor to execute the unauthorized access point (AP) data collector further comprises the processor to
monitor data communications of the unauthorized access point;
build one or more data tables from the monitored data communications of the unauthorized access point, wherein the one or more data tables include data indicative of device identifiers, and
extract the data indicative of at least the device identifier from the one or more tables.

15. The network device of claim 14, wherein the data indicative of at least the device identifier extracted from the one or more tables comprises one or more device identifiers including a basic service set identifier corresponding to the unauthorized access point.

16. The network device of claim 14, wherein the data indicative of at least the device identifier extracted from the one or more tables comprises one or more device identifiers including one or more wireless device identifiers corresponding to one or more wireless devices transmitting data to or from the unauthorized access point.

17. The network device of claim 14, wherein the data indicative of at least the device identifier extracted from the one or more tables comprises one or more device identifiers including at least one wired device identifier for a device where a second organizationally-unique device identifier associated for the device matches a corresponding organizationally-unique device identifier in a basic service set identifier of the unauthorized access point.
